(19) United States
(12) Patent Application Publication
(10) Pub. No.: US 2023/0065136 A1
(43) Pub. Date: Mar. 2, 2023

(54) SERVER DEVICE, CONFERENCE ASSISTANCE SYSTEM, CONFERENCE ASSISTANCE METHOD, AND PROGRAM STORAGE MEDIUM

(71) Applicant: NEC Corporation, Minato-ku, Tokyo (JP)

(72) Inventors: Shin Norieda, Tokyo (JP); Kenta Fukuoka, Tokyo (JP); Masashi Yoneda, Tokyo (JP); Shogo Akasaki, Tokyo (JP)

(73) Assignee: NEC Corporation, Minato-ku, Tokyo (JP)

(21) Appl. No.: 17/797,363

(22) PCT Filed: Feb. 27, 2020
(86) PCT No.: PCT/JP2020/007887

§ 371 Date: Aug. 3, 2022

(51) Int. Cl. G06F 16/635; G10L 15/08

(52) U.S. Cl. CPC G06F 16/637; G10L 15/08; G10L 2015/088

(57) ABSTRACT

Provided is a server device that enables a straightforward search for a person who is equipped with expert knowledge or a person who is highly relevant to a statement by a participant. The server device includes: a management unit; and a search request processing unit. The management unit manages an expert database that stores, for each system user, statements at a conference. The search request processing unit receives, from a terminal, an expert search request that includes a designated keyword. The search request processing unit calculates the respective degrees of expertise of the users by analyzing the statements stored in the expert database. The search request processing unit specifies an expert pertaining to the designated keyword, on the basis of the calculated degrees of expertise. The search request processing unit transmits, to the terminal, information about the specified expert.

### TECHNICAL FIELD

The present invention relates to a server device, a conference assistance system, a conference assistance method, and a program.

### BACKGROUND ART

Conferences, meetings, and the like in corporate activities and the like are important places for decision making. Various proposals have been made to efficiently conduct conferences.

For example, PTL 1 describes that contents of a conference are capitalized to improve efficiency of conference operation. A conference assistance system disclosed in PTL 1 includes an image recognition part. The image recognition unit recognizes an image related to each attendee from video data acquired by a video conference device by an image recognition technology. Furthermore, the system includes a voice recognition unit. The voice recognition unit acquires voice data of each attendee acquired by the video conference device, and compares the voice data with feature information of the voice of each attendee registered in advance. Furthermore, the voice recognition unit specifies speakers of each statement in voice data based on movement information of each attendee. Furthermore, a conference assistance system includes a timeline management unit that outputs, as a timeline, voice data of each attendee acquired by the voice recognition unit in a time series of statement.

### CITATION LIST

### Patent Literature

[PTL 1] JP 2019-061594 A

### SUMMARY OF INVENTION

### Technical Problem

In conferences, new fields, topics, and the like may be discussed. Conference participants may not have specialized knowledge about such new topics. In such a case, there may be a measure of searching information about the network and obtaining necessary knowledge. However, the information about the network is mixed, and there may be inappropriate to make an important decision based on such information.

Therefore, there is a case where an opinion of a person (hereinafter, simply described as an expert) having specialized knowledge is required in a conference. Furthermore, an agenda discussed at the conference is often for internal secrecy, and there is a demand for asking internal experts' opinions from the viewpoint of information confidentiality. However, in a large company whose number of employees exceeds several tens of thousands, it is difficult to grasp what knowledge, technology, and the like each employee has. It is conceivable to construct a database regarding knowledge of employees, but in many cases, it is a new technical field or the like that comes up on an agenda at a conference, and the information of the above-described database becomes obsolete and may not be suitable for use.

A main object of the present invention provides a server device, a conference assistance system, a conference assistance method, and a program capable of easily searching for a person having specialized knowledge or a person highly related to statements of participants.

### Solution to Problem

According to a first aspect of the present invention, there is provided a server device, including: a management unit configured to manage an expert database that stores, for each system user, statements at a conference; and a search request processing unit configured to receive, from a terminal, an expert search request that includes a designated keyword, calculate, for each system user, a degree of expertise by analyzing the statements stored in the expert database, specify an expert pertaining to the designated keyword based on the degree of expertise calculated for each system user, and transmit, to the terminal, information about the specified expert.

According to a second aspect of the present invention, there is provided a conference assistance system, including: a terminal used by a conference participant; and a server device, in which the server device includes a management unit configured to manage an expert database that stores, for each system user, statements at a conference, and a search request processing unit configured to receive, from the terminal, an expert search request that includes a designated keyword, calculate, for each system user, a degree of expertise by analyzing the statements stored in the expert database, specify an expert pertaining to the designated keyword based on the degree of expertise calculated for each system user, and transmit, to the terminal, information about the specified expert.

According to a third aspect of the present invention, there is provided a conference assistance method for a server device, including: managing an expert database that stores, for each system user, statements at a conference; receiving, from a terminal, an expert search request that includes a designated keyword; calculating, for each system user, a degree of expertise by analyzing the statements stored in the expert database; specifying an expert pertaining to the designated keyword based on the degree of expertise calculated for each system user; and transmitting, to the terminal, information about the specified expert.

According to a fourth aspect of the present invention, there is provided a computer-readable storing medium storing a program for allowing a computer installed on a server device to execute: a managing an expert database that stores, for each system user, statements at a conference; receiving, from a terminal, an expert search request that includes a designated keyword; calculating, for each system user, a degree of expertise by analyzing the statements stored in the expert database; specifying an expert pertaining to the designated keyword based on the degree of expertise calculated for each system user; and transmitting, to the terminal, information about the specified expert.

### Advantageous Effects of Invention

According to each aspect of the present invention, there are provided a server device, a conference assistance system, a conference assistance method, and a program capable of easily searching for a person having specialized knowledge or a person highly related to statements of participants. The effect of the present invention is not limited to the above. According to the present invention, other effects may be exhibited instead of or in addition to the effects.

### BRIEF DESCRIPTION OF DRAWINGS

FIG. 1 is a diagram for describing an outline of an example embodiment.

FIG. 2 is a diagram illustrating an example of a schematic configuration of a conference assistance system according to a first example embodiment.

FIG. 3 is a diagram for describing connection between a server device and a conference room according to a first example embodiment.

FIG. 4 is a diagram illustrating an example of a processing configuration of the server device according to the first example embodiment.

FIG. 5 is a diagram illustrating an example of a processing configuration of a user registration unit according to the first example embodiment.

FIG. 6 is a diagram for describing an operation of a user information acquisition unit according to the first example embodiment.

FIG. 7 is a diagram illustrating an example of a user database.

FIG. 8 is a diagram illustrating an example of a participant list.

FIG. 9 is a diagram illustrating an example of a processing configuration of an expert database management unit according to the first example embodiment.

FIG. 10 is a diagram illustrating an example of an expert database.

FIG. 11 is a diagram illustrating an example of a processing configuration of a conference room terminal according to the first example embodiment.

FIG. 12 is a diagram for describing an operation of a search request unit according to a first example embodiment.

FIG. 13 is a diagram for describing an operation of a search result output unit according to a first example embodiment.

FIG. 14 is a sequence diagram illustrating an example of an operation of a conference assistance system according to a first example embodiment.

FIG. 15 is a diagram illustrating an example of a hardware configuration of the server device.

FIG. 16 is a diagram illustrating an example of a schematic configuration of a conference assistance system according to a modification of the present disclosure.

FIG. 17 is a diagram illustrating an example of a schematic configuration of a conference assistance system according to a modification of the present disclosure.

### EXAMPLE EMBODIMENT

First, an outline of an example embodiment will be described. Reference numerals in the drawings attached to this outline are attached to each element for convenience as an example for assisting understanding, and the description of this outline is not intended to be any limitation. In addition, in a case where there is no particular explanation, blocks described in each drawing do not represent a configuration of a hardware unit but represent a configuration of a functional unit. Connection lines between blocks in each drawing include both bidirectional and unidirectional lines. The unidirectional arrow schematically indicates a flow of a main signal (data), and does not exclude bidirectionality. In the present specification and the drawings, elements that can be similarly described are denoted by the same reference numerals, and redundant description thereof can be omitted.

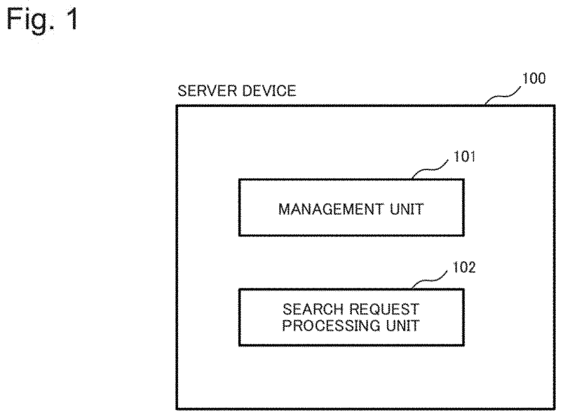

A server device 100 according to an example embodiment includes a management unit 101 and a search request processing unit 102 (see FIG. 1). The management unit 101 manages an expert database that stores, for each system user, statements at a conference. The search request processing unit 102 receives, from a terminal, an expert search request that includes a designated keyword. The search request processing unit 102 calculates the respective degrees of expertise of the users by analyzing the statements stored in the expert database. The search request processing unit 102 specifies an expert pertaining to the designated keyword, based on the calculated degrees of expertise. The search request processing unit 102 transmits, to the terminal, information about the specified expert.

The server device 100 includes an expert database that stores statements of participants in the conference. For example, the server device 100 grasps, as an expert in a field related to the keyword, a person who frequently speaks a keyword at a conference. The server device 20 analyzes the statements stored in the expert database to specify the expert of the designated keyword. The server device 100 provides information (for example, names, contact address, and the like of an expert) of the specified expert to participants of the conference. The participant can take a response such as making a call to a person specified as an expert by the server device 100 or requesting participation in a conference. That is, a person having specialized knowledge or a person highly related to a statement of a participant are easily searched.

Hereinafter, specific example embodiments will be described in more detail with reference to the drawings.

### First Example Embodiment

A first example embodiment will be described in more detail with reference to the drawings.

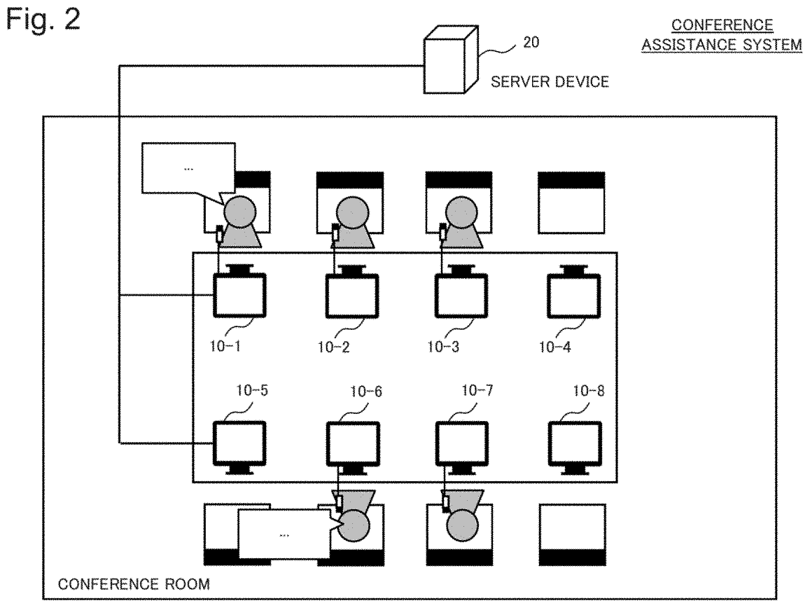

FIG. 2 is a diagram illustrating an example of a schematic configuration of a conference assistance system according to a first example embodiment. Referring to FIG. 2, the conference assistance system includes a plurality of conference room terminals 10-1 to 10-8 and a server device 20. It goes without saying that the configuration illustrated in FIG. 2 is an example and is not intended to limit the number of conference room terminals 10 and the like. Furthermore, in the following description, in a case where there is no particular reason to distinguish the conference room terminals 10-1 to 10-8, these conference room terminals 10-1 to 10-8 are simply referred to as “conference room terminals 10”.

Each of the plurality of conference room terminals 10 and the server device 20 are connected by wired or wireless communication means, and are configured to be able to communicate with each other. The server device 20 may be installed in the same room or building as the conference room, or may be installed on a network (on a cloud).

The conference room terminal 10 is a terminal installed in each seat of the conference room. The participant operates the terminal to perform a conference while displaying necessary information and the like. The conference room terminal 10 has a camera function and is configured to be able to capture an image of a participant who is seated. Further, the conference room terminal 10 is configured to be connectable to a microphone (for example, a pin microphone or a wireless microphone). The microphone collects voices of participants seated in front of each of the conference room terminals 10. The microphone connected to the conference room terminal 10 is preferably a microphone with strong directivity. This is because it is only necessary to collect a voice of a user wearing the microphone, and it is not necessary to collect a voice of another person.

The server device 20 is a device that assists a conference. The server device 20 assists a conference which is a place for decision making and a place for idea generation. The server device 20 analyzes statements of participants and accumulates information about what knowledge and technique each participant has. More specifically, the server device 20 includes an expert database (data base (DB)) that stores statements of conference participants. For example, the server device 20 associates a speaker with keywords included in statement contents, and stores these pieces of information in the expert database. The server device 20 updates an expert database each time a participant speaks. That is, the server device 20 updates an expert database in real time as a conference progresses.

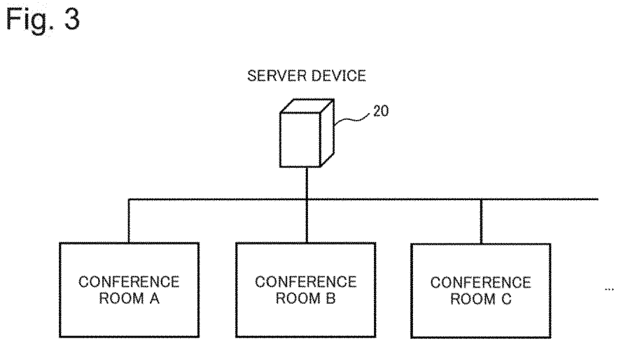

The server device 20 can update an expert database based on a conference held in one conference room, or can update an expert database based on a conference in which a plurality of conferences are held. That is, as illustrated in FIG. 3, the server device 20 constructs and updates an expert database for a conference held in at least one conference room.

As a conference progresses, when an opinion of an expert is required, a participant operates the conference room terminal 10 and inputs, to the server device 20, keywords related to the field, topics, and the like that the participant wants to know. For example, in a case where an expert's opinion on machine learning is necessary, the participant inputs a keyword such as “artificial intelligence (AI)” to the server device 20.

The server device 20 analyzes the statements stored in the expert database and calculates the respective degrees of expertise of persons registered in the database. More specifically, the server device 20 calculates the respective degree of expertise of users regarding the keyword acquired via the conference room terminal 10.

The server device 20 specifies an expert regarding a keyword acquired based on the calculated degree of expertise. For example, the server device 20 searches the expert database using the acquired keyword, and calculates the number of times of statement including the acquired keyword as the degree of expertise. The server device 20 treats a person (participant of a conference held in the past), of which the number of times of statement of a keyword is large, as an “expert”, and transmits information about the specified expert to the conference room terminal 10 that has received the keyword from the participant. For example, in the example of FIG. 2, in a case where a participant who sits in front of the conference room terminal 10-1 inputs a keyword “AI” to the server device 20, a person who frequently speaks the keyword “AI” is specified, and the information of the person is displayed on the conference room terminal 10-1.

A person of which the number of times of statement of a keyword in the past conferences is large is determined to be a person having specialized knowledge about a field, a topic, and the like including the keyword. For example, a participant makes a call to the person, makes a request to participate in the conference, or the like.

<Prior Preparation>

Here, in order to achieve conference assistance by the server device 20, a system user (a user scheduled to participate in a conference) needs to perform a prior preparation. The prior preparation will be described below.

A user registers his/her biometric information and attribute values such as profile in the system. Specifically, the user inputs a face image to the server device 20. In addition, the user inputs his/her profile (for example, information such as a name, an employee number, a workplace, an affiliated department, a position, and a contact address) to the server device 20.

Any method can be used to input information such as the biometric information and the profile. For example, a user captures his/her face image using a terminal such as a smartphone. Further, a user generates a text file or the like in which the profile is described using the terminal. A user operates the terminal to transmit the information (face image and profile) to the server device 20. Alternatively, a user may input necessary information to the server device 20 using an external storage device such as a universal serial bus (USB) in which the information is stored.

Alternatively, the server device 20 may have a function as a web server, and a user may input necessary information by a form provided by the server. Alternatively, the terminal for inputting the information may be installed in each conference room, and the user may input necessary information to the server device 20 from the terminal installed in the conference room.

The server device 20 updates the database that manages the system user using the acquired user information (biometric information, profile, etc.) Details regarding the update of the database will be described later, but the server device 20 updates the database by the following schematic operation. In the following description, a database for managing a user using the system of the present disclosure will be referred to as a “user database”.

When a person relevant to the acquired user information is a new user not registered in the user database, the server device 20 assigns an identifier (ID) to the user. In addition, the server device 20 generates a feature amount that characterizes the acquired face image.

The server device 20 adds an entry including an ID assigned to a new user, a feature amount generated from a face image, a face image of a user, a profile, and the like to the user database. When the server device 20 registers the user information, participants in a conference can use the conference assistance system illustrated in FIG. 2.

Next, details of each device included in the conference assistance system according to the first example embodiment will be described. In the first example embodiment, the case where the number of times of statement of the keyword designated from the conference room terminal 10 is calculated as the degree of expertise will be described. The degree of expertise is an index indicating knowledge, information, intelligence, a knowledge degree, and experience regarding a keyword designated by the conference room terminal 10 for each system user.

### [Server Device]

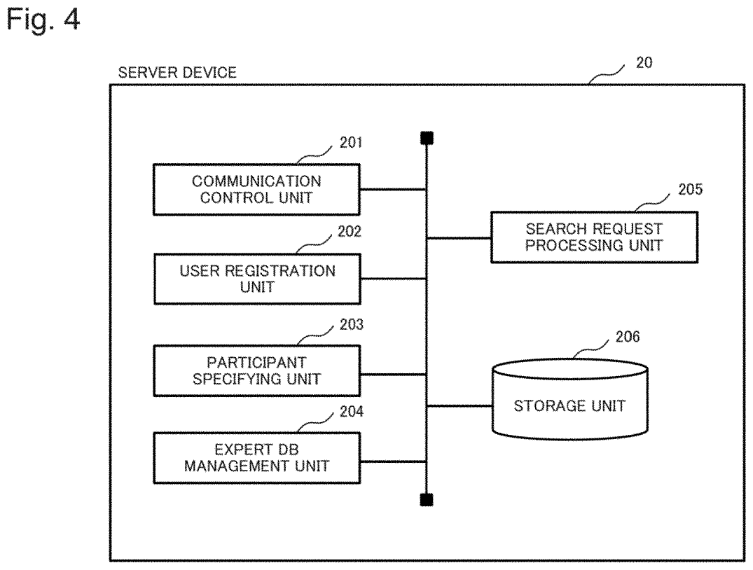

FIG. 4 is a diagram illustrating an example of a processing configuration (processing module) of the server device 20 according to the first example embodiment. Referring to FIG. 4, the server device 20 includes a communication control unit 201, a user registration unit 202, a participant specifying unit 203, an expert database management unit 204, a search request processing unit 205, and a storage unit 206.

The communication control unit 201 is a unit that controls communication with other devices. Specifically, the communication control unit 201 receives data (packet) from the conference room terminal 10. In addition, the communication control unit 201 transmits data to the conference room terminal 10. The communication control unit 201 delivers data received from another device to another processing module. The communication control unit 201 transmits data acquired from another processing module to another device. In this manner, other processing modules transmit and receive data to and from another device via the communication control unit 201.

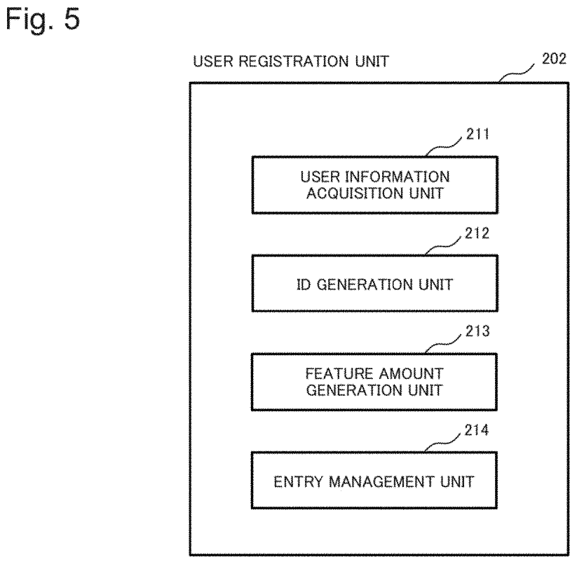

The user registration unit 202 is a unit that achieves a system user registration described above. The user registration unit 202 includes a plurality of submodules. FIG. 5 is a diagram illustrating an example of a processing configuration of the user registration unit 202. Referring to FIG. 5, the user registration unit 202 includes a user information acquisition unit 211, an ID generation unit 212, a feature amount generation unit 213, and an entry management unit 214.

The user information acquisition unit 211 is a unit that acquires the user information described above. The user information acquisition unit 211 acquires biometric information (face image) and a profile (name, affiliation, or the like) of the system user. The system user may input the information from his/her terminal to the server device 20, or may directly operate the server device 20 to input the information.

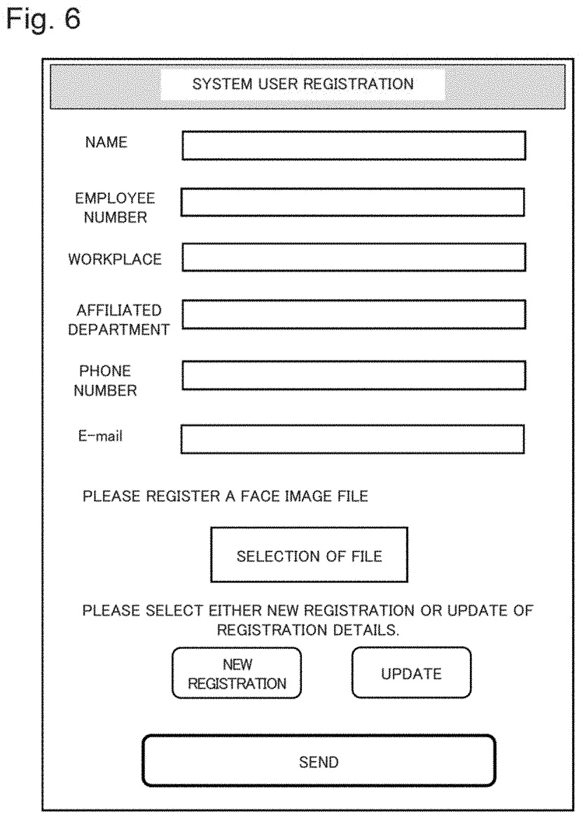

The user information acquisition unit 211 may provide a graphical user interface (GUI) or a form for inputting the information. For example, the user information acquisition unit 211 displays an information input form as illustrated in FIG. 6 on the terminal operated by the user.

The system user inputs the information illustrated in FIG. 6. In addition, the system user selects whether to newly register a user in the system or to update the already registered information. After inputting all the information, the system user presses a “transmit” button, and inputs the biometric information and the profile to the server device 20.

The user information acquisition unit 211 stores the acquired user information in the storage unit 206.

The ID generation unit 212 is a unit that generates an ID to be assigned to the system user. In a case where the user information input by the system user is information related to new registration, the ID generation unit 212 generates an ID for identifying the new user. For example, the ID generation unit 212 may calculate a hash value of the acquired user information (face image and profile) and use the hash value as the ID to be assigned to the user. Alternatively, the ID generation unit 212 may assign a unique value each time user registration is performed and use the assigned value as the ID. In the following description, an ID (ID for identifying a system user) generated by the ID generation unit 212 is referred to as a “user ID”.

The feature amount generation unit 213 is a unit that generates a feature amount (a feature vector including a plurality of feature amounts) characterizing the face image from the face image included in the user information. Specifically, the feature amount generation unit 213 extracts feature points from the acquired face image. The existing technique can be used for the feature point extraction processing, and thus a detailed description thereof will be omitted. For example, the feature amount generation unit 213 extracts eyes, a nose, a mouth, and the like as feature points from the face image. Thereafter, the feature amount generation unit 213 calculates positions of each feature point or a distance between the feature points as a feature amount, and generates a feature vector (vector information characterizing the face image) including a plurality of feature amounts.

The entry management unit 214 is a unit for managing an entry of the user database. When registering a new user in the database, the entry management unit 214 adds, to the user database, an entry including the user ID generated by the ID generation unit 212, the feature amount generated by the feature amount generation unit 213, the face image, and the profile acquired from the user.

When updating the information of the user already registered in the user database, the entry management unit 214 specifies an entry to perform the information update by the employee number or the like, and updates the user database using the acquired user information. At that time, the entry management unit 214 may update a difference between the acquired user information and the information registered in the database, or may overwrite each item of the database with the acquired user information. Similarly, regarding the feature amount, the entry management unit 214 may update the database when there is a difference in the generated feature amount, or may overwrite the existing feature amount with the newly generated feature amount.

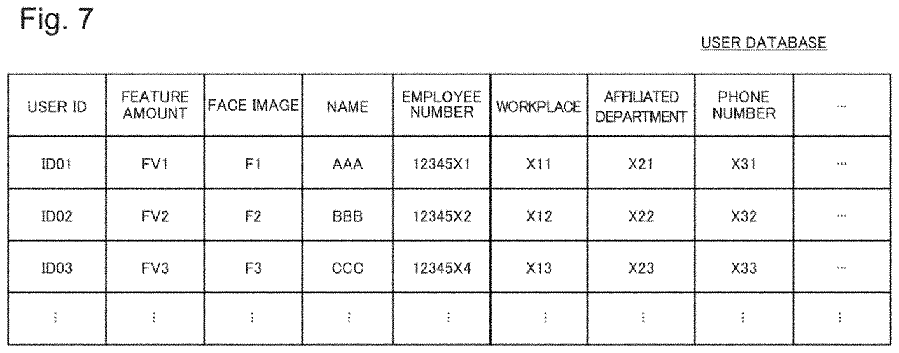

The user registration unit 202 operates to construct a user database (database that stores the user ID and the profile in association with each other) as illustrated in FIG. 7. It goes without saying that the contents registered in the user database illustrated in FIG. 7 are an example and are not intended to limit the information registered in the user database. For example, the “face image” may not be registered in the user database as necessary.

The description returns to FIG. 4. The participant specifying unit 203 is a unit that specifies a participant (user who has entered the conference room among users registered in the system) participating in the conference. The participant specifying unit 203 acquires the face image from the conference room terminal 10 in which a participant is seated among the conference room terminals 10 installed in the conference room. The participant specifying unit 203 calculates the feature amount from the acquired face image.

The participant specifying unit 203 sets the feature amount calculated based on the face image acquired from the conference room terminal 10 as a collation target, and performs collation processing with the feature amount registered in the user database. More specifically, the participant specifying unit 203 sets the calculated feature amount (feature vector) as the collation target, and executes one-to-N(N is a positive integer, and the same applies hereinafter.) collation with a plurality of feature vectors registered in the user database.

The participant specifying unit 203 calculates similarity between the feature amount to be collated and each of the plurality of feature amounts on the registration side. A chi-square distance, a Euclidean distance, or the like can be used as the similarity. The similarity is lower as the distance is longer, and the similarity is higher as the distance is shorter.

The participant specifying unit 203 specifies a feature amount having a similarity with the feature amount of the collation target that is equal to or greater than a predetermined value and having the highest similarity among a plurality of feature amounts registered in the user database.

The participant specifying unit 203 reads the user ID relevant to the feature amount obtained as a result of the one-to-N collation from the user database.

The participant specifying unit 203 repeats the above-described processing on the face image acquired from each of the conference room terminals 10, and specifies the user ID relevant to each face image. The participant specifying unit 203 generates a participant list by associating the specified user ID with the ID of the conference room terminal 10 which is a transmission source of the face image. As the ID of the conference room terminal 10, a media access control (MAC) address or an internet protocol (IP) address of the conference room terminal 10 can be used.

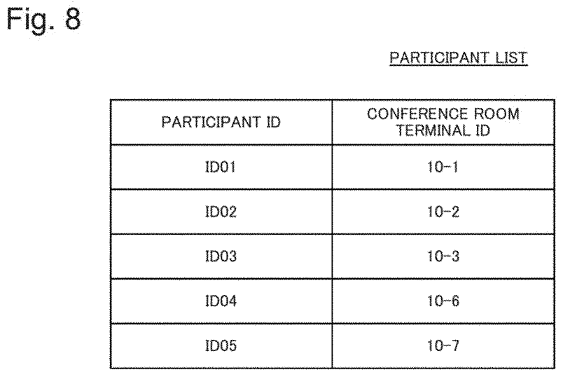

For example, in the example of FIG. 2, the participant list as illustrated in FIG. 8 is generated. In FIG. 8, for easy understanding, a reference numeral attached to the conference room terminal 10 are described as an ID of a conference room terminal. In addition, the “participant ID” included in the participant list is a user ID registered in the user database.

In this manner, the server device 20 performs collation using the biometric information (face image) transmitted from the conference room terminal 10 and the biometric information (feature amount) stored in the user database to specify participants of the conference. The server device 20 generates a participant list in which the user ID relevant to the specified participant is associated with the ID of the conference room terminal 10 used by the specified participant.

The expert database management unit 204 is a unit that manages an expert database that stores information about experts (knowledgeable persons) having expert knowledge regarding specific fields and specific topics. The management unit manages an expert database that stores, for each system user, statements at a conference. In particular, the expert database stores the number of times each user has made statements including keywords.

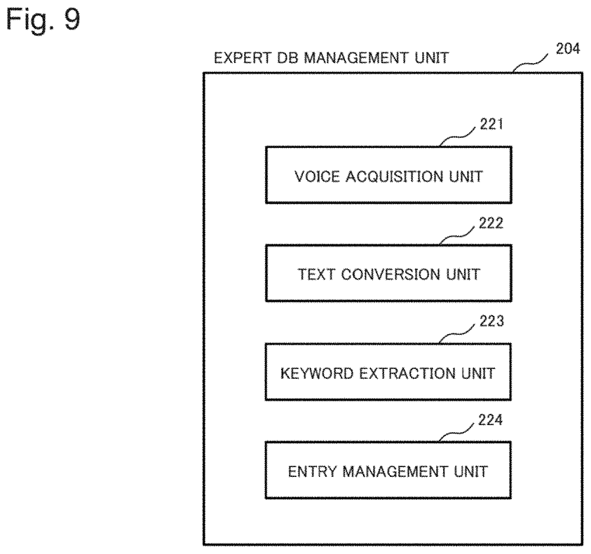

The expert database management unit 204 includes a plurality of submodules. FIG. 9 is a diagram illustrating an example of a processing configuration of the expert database management unit 204. Referring to FIG. 9, the expert database management unit 204 includes a voice acquisition unit 221, a text conversion unit 222, a keyword extraction unit 223, and an entry management unit 224.

The voice acquisition unit 221 is a unit that acquires the voice of the participant from the conference room terminal 10. The conference room terminal 10 generates a voice file each time a participant makes a statement, and transmits the voice file to the server device 20 together with an ID (ID of conference room terminal) of an own device. The voice acquisition unit 221 specifies a participant ID relevant to the acquired ID of the conference room terminal by referring to the participant list. The voice acquisition unit 221 delivers the specified participant ID and the voice file acquired from the conference room terminal 10 to the text conversion unit 222.

The text conversion unit 222 converts the acquired voice file into text. The text conversion unit 222 converts the contents recorded in the voice file into text using an audio recognition technology. Since the text conversion unit 222 can use the existing voice recognition technology, detailed description thereof is omitted, but the text conversion unit schematically operates as follows.

The text conversion unit 222 performs filter processing for removing noise and the like from the voice file. Next, the text conversion unit 222 specifies phonemes from a sound wave of the voice file. The phoneme is the smallest constituent unit of a language. The text conversion unit 222 specifies a string of phonemes and converts the string into words. The text conversion unit 222 creates a sentence from a string of words and outputs a text file. At the time of the filter processing, since the voice smaller than the predetermined level is deleted, even when a voice of neighbor is included in the voice file, the text file is not generated from the voice of the neighbor.

The text conversion unit 222 delivers the participant ID and the text file to the keyword extraction unit 223.

The keyword extraction unit 223 is a unit that extracts a keyword from the text file. For example, the keyword extraction unit 223 refers to an extraction keyword list (table information) in which keywords to be extracted are described in advance to extract the keywords described in the list from the text file. Alternatively, the keyword extraction unit 223 may extract a noun included in the text file as a keyword.

For example, a case where a participant makes a statement that “AI is becoming more and more important technology” is considered. In this case, when the word “AI” is registered in the extracted keyword list, the “AI” is extracted from the above statement. Alternatively, in a case where a noun is extracted, “AI” and “technology” are extracted. The existing part-of-speech decomposition tool (app) or the like may be used to extract nouns.

The keyword extraction unit 223 delivers the participant ID and the extracted keyword to the entry management unit 224.

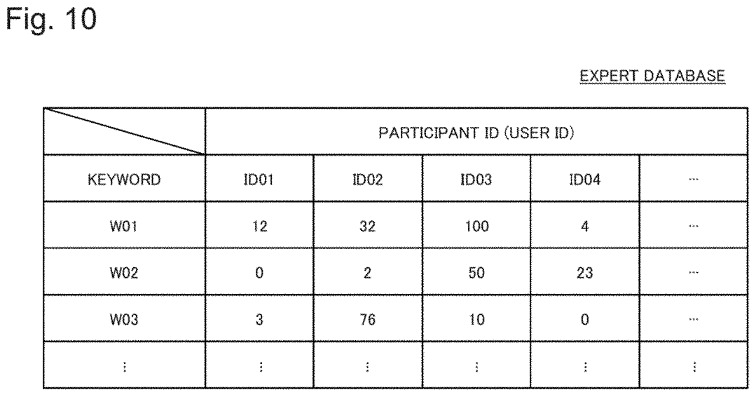

The entry management unit 224 is a unit that manages the entry of the expert database. The expert database stores the number of times of statement of each system user for each keyword. FIG. 10 is a diagram illustrating an example of an expert database. As illustrated in FIG. 10, the number of times the system user has stated a keyword in a conference (past conference and ongoing conference) is stored in the expert database.

The entry management unit 224 updates the expert database based on the acquired participant ID and the keyword. In this manner, the server device 20 specifies the user ID relevant to a speaker by referring to the participant list using the ID of the conference room terminal 10 used by the participant. Further, the server device 20 extracts a keyword from the voice acquired from the conference room terminal 10 used by the participant, and updates the expert database using the specified user ID and the extracted keyword.

The description returns to FIG. 4. The search request processing unit 205 is a unit that processes the “expert search request” acquired from the conference room terminal 10. The expert search request includes keywords related to fields, topics, and the like that participants of a conference want to know. The search request processing unit 205 receives an expert search request including a keyword designated by a conference participant or the like from the conference room terminal 10. The search request processing unit 205 specifies an expert regarding the designated keyword by referring to the expert database. The search request processing unit 205 transmits, to the conference room terminal 10, the information about the specified expert.

Specifically, the search request processing unit 205 extracts a keyword from the expert search request and searches the expert database using the extracted keyword. The search request processing unit 205 specifies an entry having a keyword matching the extracted keyword among the keywords registered in the expert database. The search request processing unit 205 confirms a participant ID field of the specified entry, and specifies a participant ID having the largest number of registered times (the number of times of statement).

For example, in the example of FIG. 10, in a case where a keyword “W01” is included in the expert search request, a participant ID of “ID03” is specified. That is, in FIG. 10, for the keyword “W01”, the degree of expertise of a person relevant to “ID03” is the highest, and the participant ID of the person is specified.

The search request processing unit 205 searches the user database (see FIG. 7) using the specified participant ID. The search request processing unit 205 generates a response (response to the search request) including information (for example, a face image, a name, an affiliated department, a telephone number (contact address), and the like.) of the entry specified by searching the user database, and transmits the generated response to the conference room terminal 10 which is a transmission source of the expert search request.

Alternatively, the search request processing unit 205 may transmit the response to the search request to the conference room terminal 10 used by each participant participating in the conference. For example, in the examples of FIGS. 2 and 8, the above response may be transmitted to the conference room terminals 10-1 to 10-3, 10-6, and 10-7. That is, the response to the search request may be transmitted to the conference room terminal 10 relevant to the conference room terminal ID described in the participant list.

The storage unit 206 is a unit that stores information necessary for the operation of the server device 20.

### [Conference Room Terminal]

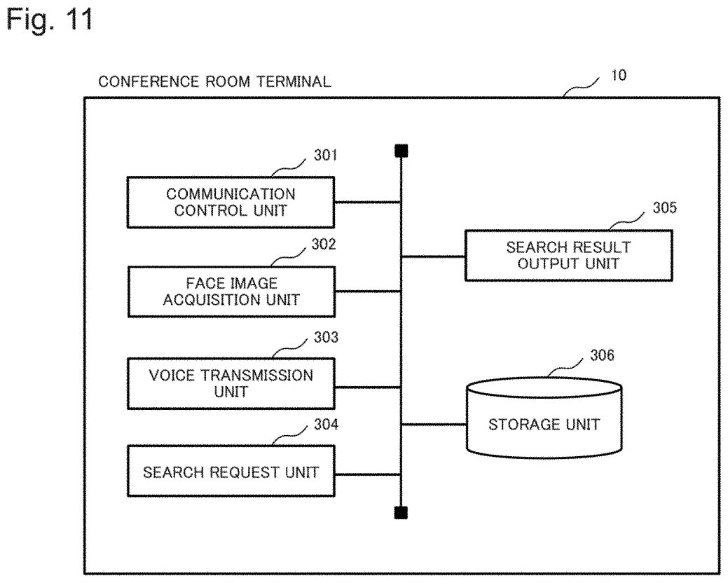

FIG. 11 is a diagram illustrating an example of a processing configuration (processing module) of the conference room terminal 10. Referring to FIG. 11, the conference room terminal 10 includes a communication control unit 301, a face image acquisition unit 302, a voice transmission unit 303, a search request unit 304, a search result output unit 305, and a storage unit 306.

The communication control unit 301 is a unit that controls communication with other devices. Specifically, the communication control unit 301 receives data (packet) from the server device 20. Furthermore, the communication control unit 301 transmits data to the server device 20. The communication control unit 301 delivers data received from another device to another processing module. The communication control unit 301 transmits data acquired from another processing module to another device. In this manner, other processing modules transmit and receive data to and from another device via the communication control unit 301.

The face image acquisition unit 302 is a unit that controls a camera device to acquire a face image (biometric information) of a participant seated in front of an own device. The face image acquisition unit 302 captures an image of the front of the own device periodically or at a predetermined timing. The face image acquisition unit 302 determines whether a face image of a person is included in the acquired image, and extracts the face image from the acquired image data when the face image is included. The face image acquisition unit 302 transmits a set of the extracted face image and the ID (conference room terminal ID; for example, an IP address) of the own device to the server device 20.

Since the existing technology can be used for the face image detection processing and the face image extraction processing by the face image acquisition unit 302, detailed description thereof will be omitted. For example, the face image acquisition unit 302 may extract a face image (face area) from image data by using a learning model trained by a convolutional neural network (CNN). Alternatively, the face image acquisition unit 302 may extract a face image using a method such as template matching.

The voice transmission unit 303 is a unit that acquires a voice of a participant and transmits the acquired voice to the server device 20. The voice transmission unit 303 acquires a voice file related to a voice collected by a microphone (for example, a pin microphone). For example, the voice transmission unit 303 acquires a voice file encoded in a format such as a waveform audio file (WAV file).

The voice transmission unit 303 analyzes the acquired voice file, and when the voice file includes a voice section (a section that is not silent; a participant's statement), transmits the voice file including the voice section to the server device 20. At that time, the voice transmission unit 303 transmits the voice file and the ID (conference room terminal ID) of the own device to the server device 20.

Alternatively, the voice transmission unit 303 may attach the conference room terminal ID to the voice file acquired from the microphone and transmit the voice file as it is to the server device 20. In this case, the voice file acquired by the server device 20 may be analyzed to extract the voice file including a voice.

The voice transmission unit 303 extracts a voice file (voice file that is not silent) including the statement of the participant using the existing “audio detection technology”. For example, the voice transmission unit 303 performs the voice detection using a voice parameter sequence or the like modeled by a hidden Markov model (HMM).

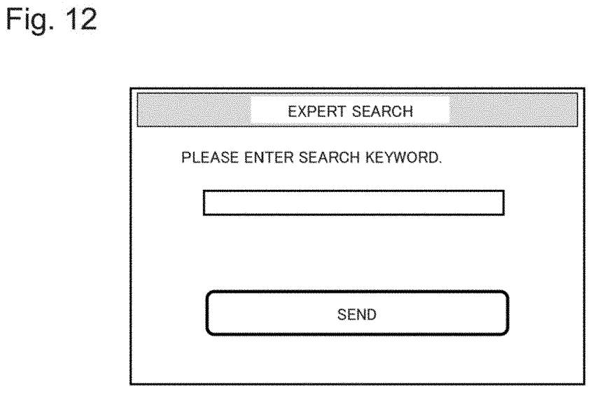

The search request unit 304 is a unit that generates the “expert search request” described above according to the operation of the participant and transmits the generated request to the server device 20. For example, the search request unit 304 generates a GUI for a participant to input a keyword. For example, the search request unit 304 displays a screen as illustrated in FIG. 12 on the display.

The search request unit 304 generates an expert search request including a keyword acquired via the GUI and the conference room terminal ID of the own device, and transmits the generated expert search request to the server device 20.

The search request unit 304 acquires a response to the request from the server device 20. The search request unit 304 delivers the acquired response to the search result output unit 305.

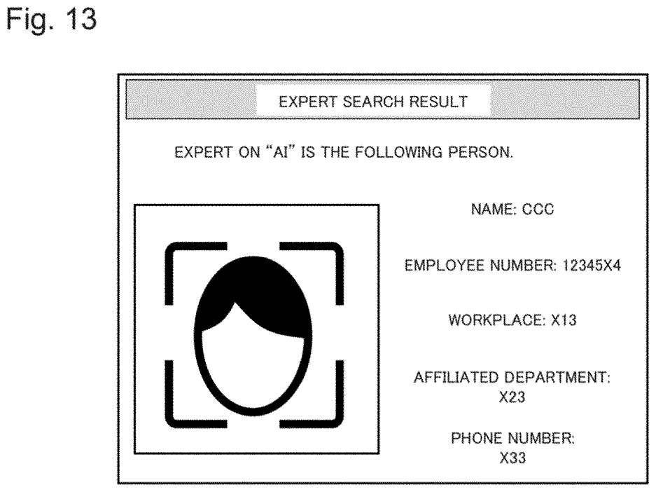

The search result output unit 305 is a unit that outputs the response (the result of the expert search by the server device 20) acquired from the server device 20. The search result output unit 305 displays information about a person specified as the “expert” by the server device 20. For example, the search result output unit 305 displays a screen as illustrated in FIG. 13 on the display.

As illustrated in FIG. 13, as a result of the expert search, a name, an employee number, a workplace, and the like of the expert specified by the server device 20 are presented to participants of a conference. The display illustrated in FIG. 13 is an example and is not intended to limit the output contents of the search result output unit 305. For example, information (for example, the number of times of statement of the designated keyword) that is a basis for specifying an expert may be displayed together with a name or the like. Furthermore, the search result output unit 305 may print the search result, or may transmit the search result to a predetermined e-mail address or the like.

The storage unit 306 is a unit that stores information necessary for the operation of the conference room terminal 10.

### [Operation of Conference Assistance System]

Next, an operation of the conference assistance system according to the first example embodiment will be described.

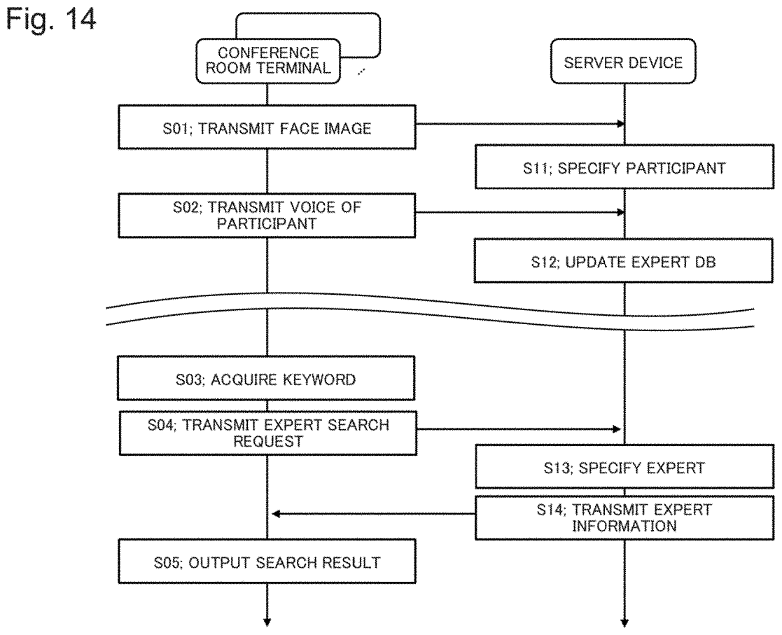

FIG. 14 is a sequence diagram illustrating an example of an operation of the conference assistance system according to the first example embodiment of the present invention; FIG. 14 is a sequence diagram illustrating an example of an operation of a system when a conference is actually held. It is assumed that a system user is registered in advance prior to the operation of FIG. 14.

When a conference starts and a participant is seated, the conference room terminal 10 acquires a face image of the seated participant and transmits the face image to the server device 20 (step S01).

The server device 20 specifies the participant using the acquired face image (step S11). The server device 20 sets a feature amount calculated from the acquired face image as a feature amount on the collation side and sets a plurality of feature amounts registered in a user database as a feature amount on a registration side, and executes a one-to-N(N is a positive integer, and the same applies hereinafter) collation. The server device 20 repeats the collation for each participant (the conference room terminal 10 used by the participant) to the conference and generates a participant list.

The conference room terminal 10 acquires voices of participants and transmits the voices to the server device 20 (step S02). That is, the voices of the participants are collected by the conference room terminal 10 and sequentially transmitted to the server device 20.

The server device 20 analyzes the acquired voice (voice file) and extracts a keyword from a statement of a participant. The server device 20 updates the expert database using the extracted keyword and participant ID (step S12).

While the conference is being held, the processes of steps S02 and S12 are repeated. As a result, the information about the number of times of keyword statement by the system user is accumulated in the expert database, including the currently ongoing conference.

In the conference, when an opinion of an expert is required, the participant inputs, to the conference room terminal 10, a keyword related to a topic or the like that the participant wants to know. The conference room terminal 10 acquires a keyword (step S03).

The conference room terminal 10 transmits an expert search request including the acquired keyword to the server device 20 (step S04).

The server device 20 searches the expert database using the acquired keyword, and specifies the system user (expert) who speaks the keyword the most (step S13). In this manner, the server device 20 specifies the expert based on the number of times of statement (degree of expertise) of the keyword designated by the user or the like. More specifically, the server device 20 treats, as an “expert”, a speaker of which the number of times of statement of the designated keyword is largest.

The server device 20 acquires information (expert information) about the specified expert by referring to the user database. For example, the server device 20 acquires a face image, a name, an affiliated department, a telephone number, and the like of the specified expert from the user database.

The server device 20 transmits a response (response to the expert search request) including the acquired expert information to the conference room terminal 10 (step S14). In this manner, the server device 20 acquires a profile of the specified expert by referring to the user database, and transmits the acquired profile to the conference room terminal 10.

The conference room terminal 10 outputs the acquired response (expert search result) (step S05).

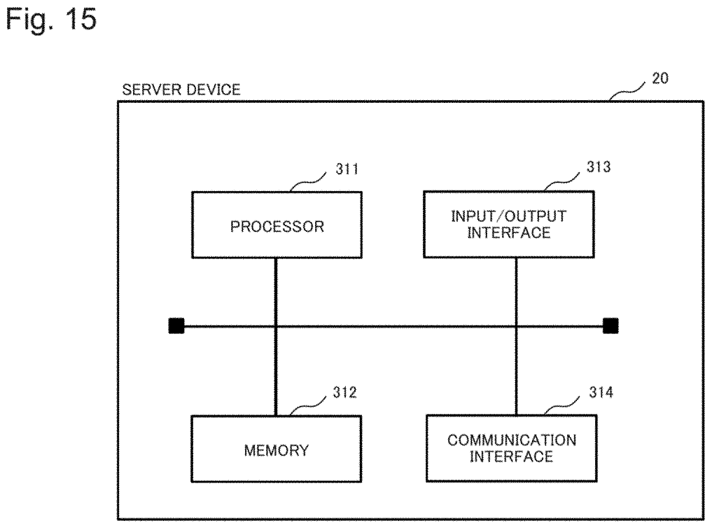

Next, hardware of each device constituting the conference assistance system will be described. FIG. 15 is a diagram illustrating an example of a hardware configuration of the server device 20.

The server device 20 can be configured by an information processing device (so-called computer), and has the configuration illustrated in FIG. 15. For example, the server device 20 includes a processor 311, a memory 312, an input/output interface 313, a communication interface 314, and the like. The components such as the processor 311 are connected by an internal bus or the like, and are configured to be able to communicate with each other.

However, the configuration illustrated in FIG. 15 is not intended to limit the hardware configuration of the server device 20. The server device 20 may include hardware (not illustrated) or may not include the input/output interface 313 as necessary. In addition, the number of processors 311 and the like included in the server device 20 is not limited to the example of FIG. 15, and for example, a plurality of processors 311 may be included in the server device 20.

The processor 311 is a programmable device such as a central processing unit (CPU), a micro processing unit (MPU), or a digital signal processor (DSP). Alternatively, the processor 311 may be a device such as a field programmable gate array (FPGA) or an application specific integrated circuit (ASIC). The processor 311 executes various types of programs including an operating system (OS).

The memory 312 is a random access memory (RAM), a read only memory (ROM), a hard disk drive (HDD), a solid state drive (SSD), or the like. The memory 312 stores an OS program, an application program, and various pieces of data.

The input/output interface 313 is an interface of a display device or an input device (not illustrated). The display device is, for example, a liquid crystal display or the like. The input device is, for example, a device that receives a user operation such as a keyboard or a mouse.

The communication interface 314 is a circuit, a module, or the like that communicates with another device. For example, the communication interface 314 includes a network interface card (NIC) or the like.

The functions of the server device 20 are implemented by various processing modules. The processing module is implemented, for example, by the processor 311 executing a program stored in the memory 312. In addition, the program can be recorded in a computer-readable storing medium. The storing medium can be a non-transient (non-transitory) medium such as a semiconductor memory, a hard disk, a magnetic recording medium, or an optical recording medium. That is, the present invention can also be embodied as a computer program product. In addition, the program can be downloaded via a network or updated using a storing medium storing the program. Further, the processing module may be achieved by a semiconductor chip.

The conference room terminal 10 can also be configured by an information processing device similarly to the server device 20, and since there is no difference in the basic hardware configuration from the server device, the description will be omitted. The conference room terminal 10 may include a camera and a microphone, or may be configured to be connectable with the camera or the microphone.

The server device 20 is equipped with a computer, and the function of the server device 20 can be achieved by causing the computer to execute a program.

As described above, the server device 20 according to the first example embodiment constructs the user database that stores the user ID, the biometric information (for example, a face image or a feature amount generated from the face image) of the user, and the profile (attribute value) of the user in association with each other. Furthermore, the server device 20 constructs an expert database that stores keywords spoken at the conference and speakers in association with each other. The server device 20 specifies an expert regarding the keyword designated by the user by searching the expert database. The server device 20 acquires the profile of the specified expert by referring to the user database, and transmits the acquired profile to the conference room terminal 10. For example, participants of a conference can take measures such as making a call to a person specified as an expert by the server device 20 or making a request to participate in the conference. That is, the conference assistance system according to the first example embodiment makes it possible to easily search for a person having specialized knowledge.

### Modification

The configuration, operation, and the like of the conference assistance system described in the above example embodiment are merely examples, and are not intended to limit the configuration and the like of the system.

In the above example embodiment, the number of times of statement of the keyword in the conference is treated as the degree of expertise. That is, in a case where a conference is held by a plurality of persons (in a case where a conference is held by a plurality of persons), the fact that the number of times of statement is large is quantified and calculated as the degree of expertise. However, the degree of expertise is not limited to the number of times of statement of the keyword, and the degree of expertise can be determined by various calculation methods or the like. For example, the server device 20 may normalize the number of keywords with the number of words stated in one sentence and calculate the normalized number of times as the “degree of expertise”.

Alternatively, the server device 20 may calculate the degree of expertise based on a combination of a plurality of keywords. For example, when defining an expert of “AI” (a degree of expertise regarding a keyword of AI), the server device 20 may calculate the degree of expertise by the number of times of statement obtained by adding two keywords of “machine learning” and “weight”. In this case, a person of which only the number of times of statement of the keyword “machine learning” is large is not treated as an expert, and a person of which the number of times of statement of the keyword “weight” more specialized in the AI technology is large is specified as an expert.

Alternatively, the keyword may be abstracted by a synonym or the like, and the degree of expertise may be calculated based on the synonym. For example, keywords such as “AI” and “CNN” are treated as the synonym “machine learning”, and the degree of expertise may be calculated.

Alternatively, a mechanism in which another person scores a statement of a participant may be introduced, and the degree of expertise may be calculated by the score.

The server device 20 may store the statement itself of each participant and use the statement itself for calculating the degree of expertise.

For example, in a case where many predetermined keywords are included in the statement of the participant, the server device 20 may specify the participant of the statement as an expert. In this case, the server device 20 may transmit characteristic sentences (sentences determined to have a high degree of expertise) of experts to the conference room terminal 10. The conference room terminal 10 may display the characteristic sentence (statement) together with the profile (name or the like) of the expert.

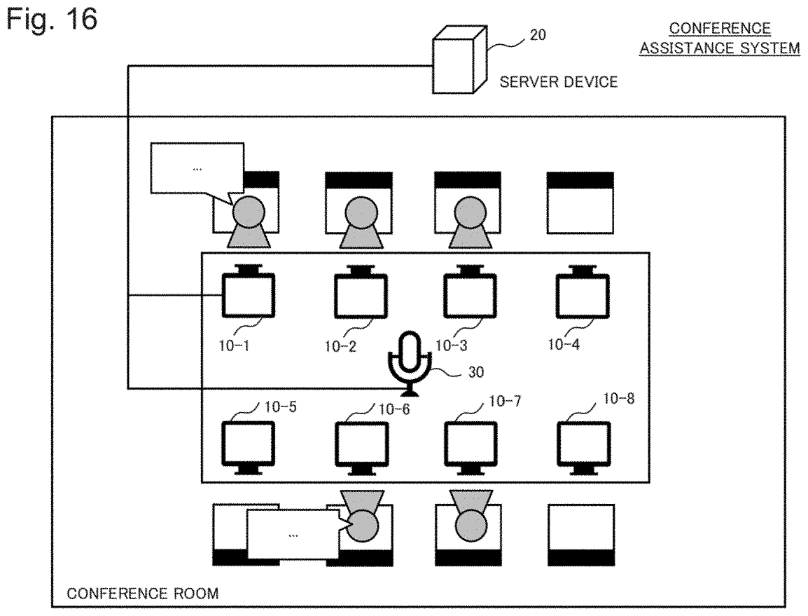

In the above example embodiment, a microphone is connected to the conference room terminal 10, and a speaker is specified by an ID of the conference room terminal 10 that transmits a voice. However, as illustrated in FIG. 16, one microphone 30 may be installed at a desk, and the microphone 30 may collect statements of each participant. In this case, the server device 20 may execute “speaker identification” on the voice collected from the microphone 30 to specify the speaker.

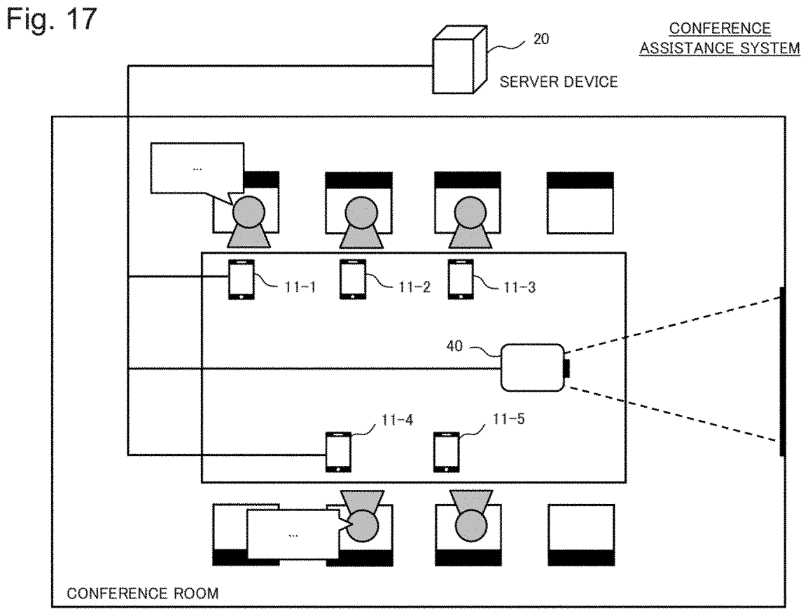

In the above example embodiment, the case where the dedicated conference room terminal 10 is installed on the desk has been described, but the function of the conference room terminal 10 may be achieved by a terminal carried (possessed) by a participant. For example, as illustrated in FIG. 17, each of the participants may participate in a conference by using terminals 11-1 to 11-5. The participant operates his/her terminal 11 and transmits his/her face image to the server device 20 at the start of the conference. In addition, the terminal 11 transmits the voice of the participant to the server device 20. The server device 20 may provide an image, a video, or the like to a participant using a projector 40.

The profile (attribute value of the user) of the system user may be input using a scanner or the like. For example, the user inputs an image related to his/her business card to the server device 20 using the scanner. The server device 20 executes optical character recognition (OCR) processing on the acquired image. The server device 20 may determine the profile of the user based on the acquired information.

In the above example embodiment, the case where the biometric information related to the “face image” is transmitted from the conference room terminal 10 to the server device 20 has been described. However, the biometric information related to “the feature amount generated from the face image” may be transmitted from the conference room terminal 10 to the server device 20. The server device 20 may execute the collation processing with the feature amount registered in the user database using the acquired feature amount (feature vector).

In the above example embodiment, the server device 20 specifies one expert regarding the designated keyword by referring to the expert database, and provides the information (professional information; profile, attribute information) to participants of a conference. However, the server device 20 may specify two or more experts and transmit information about the two or more experts to the conference room terminal 10. In this case, the conference room terminal 10 may simultaneously display (display on the same screen) profiles and the like related to a plurality of experts. Alternatively, the conference room terminal 10 may take a measure such as displaying a person having high expertise side by side in descending order. For example, the conference room terminal 10 may display a person of which the number of times of statement is largest at the top. Alternatively, the conference room terminal 10 may take a measure such as displaying a person in the same department as the user of the terminal at the top.

In the above example embodiment, the case where the server device 20 specifies an expert based on the number of times of statement of a keyword matching a keyword acquired from the conference room terminal 10 has been described. However, the server device 20 may specify an expert based on the number of times of statement of a keyword (similar keyword) substantially matching the designated keyword. For example, a manager or the like inputs similar keywords to the server device 20 in advance. For example, keywords such as AI and machine learning are input to the server device 20 as similar keywords. For example, in a case where the keyword “AI” is designated, the server device 20 may specify an expert based on the number of times of statement of “machine learning” in addition to “AI”. For example, although the designated keyword is “AI”, the server device 20 may specify a person having the largest total number of statements of two keywords (AI, machine learning) as an expert.

In the display of the expert search result as illustrated in FIG. 13, the conference room terminal 10 may also display contents of statements by the displayed expert, a history of stated keywords, or the like.

Alternatively, the conference room terminal 10 may be provided with a button (for example, a button for transmitting a mail and a button for making a call.) for contacting an expert in the display illustrated in FIG. 13.

In the above example embodiment, the case where the “expert search request” is transmitted from the conference room terminal 10 has been described. However, the participants of the conference may transmit the expert search request from their own terminals (terminals such as smartphones). Alternatively, the system user not participating in the conference may operate the terminal to transmit the expert search request to the server device 20. That is, the “expert search request” may be transmitted to the server device 20 for the purpose of searching for users who participate in the conference.

Alternatively, even if there is no explicit instruction from the participant or the like, the server device 20 may extract a keyword from the statement contents of the participant, search the expert database using the extracted keyword as a search key, and transmit the search result to the conference room terminal 10.

In the flow chart (flowchart and sequence Diagram) used in the above description, a plurality of steps (processes) are described in order, but the execution order of the steps executed in the example embodiment is not limited to the described order. In the example embodiment, for example, the order of the illustrated steps, such as executing each process in parallel, can be changed within a range in which there is no problem in terms of contents.

The above example embodiments have been described in detail in order to facilitate understanding of the present disclosure, and it is not intended that all the configurations described above are necessary. In addition, in a case where a plurality of example embodiments has been described, each example embodiment may be used alone or in combination. For example, a part of the configuration of the example embodiment can be replaced with the configuration of another example embodiment, or the configuration of another example embodiment can be added to the configuration of the example embodiment. Furthermore, it is possible to add, delete, and replace other configurations for a part of the configuration of the example embodiment.

Although the industrial applicability of the present invention is apparent from the above description, the present invention can be suitably applied to a system or the like that assists a conference or the like performed by a company or the like.

Some or all of the above example embodiments may be described as the following supplementary notes, but are not limited thereto.

### Supplementary Note 1

A server device, including:

a management unit configured to manage an expert database that stores, for each system user, statements at a conference; and

a search request processing unit configured to receive, from a terminal, an expert search request that includes a designated keyword, calculate, for each system user, a degree of expertise by analyzing the statements stored in the expert database, specify an expert pertaining to the designated keyword based on the degree of expertise calculated for each system user, and transmit, to the terminal, information about the specified expert.

### Supplementary Note 2

The server device disclosed in claim 1, wherein

the search request processing unit specifies the expert based on the number of times of statements of the designated keyword.

### Supplementary Note 3

The server device disclosed in claim 1 or 2, wherein

the search request processing unit sets, as the expert, a speaker having a largest number of statements of the designated keyword.

### Supplementary Note 4

The server device disclosed in any one of claims 1 to 3, further including:

a user database configured to store an identifier (ID) of a user and a profile in association with each other,

in which the search request processing unit acquires a profile of the specified expert by referring to the user database, and transmits the acquired profile to the terminal.

### Supplementary Note 5

The server device disclosed in claim 4, wherein

the profile of the expert includes at least one or more of a name, an affiliation, a contact address, and a sentence serving as a basis for specifying the expert.

### Supplementary Note 6

The server device disclosed in claim 4 or 5, wherein

the user database stores the user ID, biometric information of the user, and the profile of the user in association with each other, and

the server device further includes a participant specifying unit configured to perform collation using biometric information transmitted from the terminal and the biometric information stored in the user database and specify a participant of a conference.

### Supplementary Note 7

The server device disclosed in claim 6, wherein

the participant specifying unit generates a participant list in which the user ID relevant to the specified participant is associated with an ID of a terminal used by the specified participant.

### Supplementary Note 8

The server device disclosed in claim 7, wherein

the management unit specifies the user ID relevant to the speaker by referring to the participant list using the ID of the terminal used by the participant, extracts a keyword from a voice acquired from the terminal used by the participant, and updates the expert database using the specified user ID and the extracted keyword.

### Supplementary Note 9

The server device disclosed in claim 8, wherein

the management unit extracts the keyword by referring to table information in which a keyword to be extracted is determined in advance.

### Supplementary Note 10

A conference assistance system, including:

a terminal used by a conference participant; and

a server device,

in which the server device includes:

a management unit configured to manage an expert database that stores, for each system user, statements at a conference; and

a search request processing unit configured to receive, from the terminal, an expert search request that includes a designated keyword, calculate, for each system user, a degree of expertise by analyzing the statements stored in the expert database, specify an expert pertaining to the designated keyword based on the degree of expertise calculated for each system user, and transmit, to the terminal, information about the specified expert.

### Supplementary Note 11

A conference assistance method for a server device including:

managing an expert database that stores, for each system user, statements at a conference;

receiving, from a terminal, an expert search request that includes a designated keyword;

calculating, for each system user, a degree of expertise by analyzing the statements stored in the expert database;

specifying an expert pertaining to the designated keyword based on the degree of expertise calculated for each system user; and

transmitting, to the terminal, information about the specified expert.

### Supplementary Note 12

A computer-readable storing medium storing a program for allowing a computer installed on a server device to execute:

managing an expert database that stores, for each system user, statements at a conference;

receiving, from a terminal, an expert search request that includes a designated keyword;

calculating, for each system user, a degree of expertise by analyzing the statements stored in the expert database;

specifying an expert pertaining to the designated keyword based on the degree of expertise calculated for each system user; and

transmitting, to the terminal, information about the specified expert.

The forms of the supplementary notes 10 to 12 can be expanded to the forms of the supplementary notes 2 to 9, similarly to the form of the supplementary note 1.

Each disclosure of the citation lists is incorporated herein by reference. Although the example embodiments of the present invention have been described above, the present invention is not limited to these example embodiments. It will be understood by those of ordinary skill in the art that these example embodiments are exemplary only and that various variations are possible without departing from the scope and spirit of the invention. That is, it goes without saying that the present invention includes various variations and modifications that can be made by those of ordinary skill in the art in accordance with the entire disclosure including the claims and the technical idea.

### REFERENCE SIGNS LIST

10, 10-1 to 10-8 Conference room terminal
11, 11-1 to 11-5 Terminal
20, 100 Server device
30 Microphone
40 Projector
101 Management unit
102, 205 Search request processing unit
201, 301 Communication control unit
202 User registration unit
203 Participant specifying unit
204 Expert database management unit
206, 306 Storage unit
211 User information acquisition unit
212 ID generation unit
213 Feature amount generation unit
214, 224 Entry management unit
221 Voice acquisition unit
222 Text conversion unit
223 Keyword extraction unit
302 Face image acquisition unit
303 Voice transmission unit
304 Search request unit
305 Search result output unit
311 Processor
312 Memory
313 Input/output interface
314 Communication interface

What is claimed is:

1. A server device, comprising:
at least one processor configured to:
manage an expert database that stores, for each system user, statements at a conference; and
receive, from a terminal, an expert search request that includes a designated keyword, calculate, for each system user, a degree of expertise by analyzing the statements stored in the expert database, specify an expert pertaining to the designated keyword based on the degree of expertise calculated for each system user, and transmit, to the terminal, information about the specified expert.

2. The server device according to claim 1, wherein the at least one processor specifies the expert based on the number of times of statements of the designated keyword.

3. The server device according to claim 1, wherein the at least one processor sets, as the expert, a speaker having a largest number of statements of the designated keyword.

4. The server device according to claim 1, further comprising:
a user database configured to store an identifier (ID) of a user and a profile in association with each other,
wherein the at least one processor acquires a profile of the specified expert by referring to the user database, and transmits the acquired profile to the terminal.

5. The server device according to claim 4, wherein the profile of the expert includes at least one or more of a name, an affiliation, a contact address, and a sentence serving as a basis for specifying the expert.

6. The server device according to claim 4, wherein
the user database stores the user ID, biometric information of the user, and the profile of the user in association with each other, and
the at least one processor is further configured to perform collation using biometric information transmitted from the terminal and the biometric information stored in the user database and specify a participant of a conference.

7. The server device according to claim 6, wherein the at least one processor generates a participant list in which the user ID relevant to the specified participant is associated with an ID of a terminal used by the specified participant.

8. The server device according to claim 7, wherein the at least one processor specifies the user ID relevant to the speaker by referring to the participant list using the ID of the terminal used by the participant, extracts a keyword from a voice acquired from the terminal used by the participant, and updates the expert database using the specified user ID and the extracted keyword.

9. The server device according to claim 8, wherein the at least one processor extracts the keyword by referring to table information in which a keyword to be extracted is determined in advance.

10. (canceled)

11. A conference assistance method for a server device comprising:
by a computer,
managing an expert database that stores, for each system user, statements at a conference;
receiving, from a terminal, an expert search request that includes a designated keyword;
calculating, for each system user, a degree of expertise by analyzing the statements stored in the expert database;
specifying an expert pertaining to the designated keyword based on the degree of expertise calculated for each system user; and
transmitting, to the terminal, information about the specified expert.

12. A non-transitory computer-readable storing medium storing a program for allowing a computer installed on a server device to execute:
managing an expert database that stores, for each system user, statements at a conference;
receiving, from a terminal, an expert search request that includes a designated keyword;
calculating, for each system user, a degree of expertise by analyzing the statements stored in the expert database;
specifying an expert pertaining to the designated keyword based on the degree of expertise calculated for each system user; and
transmitting, to the terminal, information about the specified expert.
